(19) United States
(12) Patent Application Publication
(10) Pub. No.: US 2008/0075946 A1
(43) Pub. Date: Mar. 27, 2008

(54) Layered Composite Material, And Corresponding Device For Application Of Cosmetics

(75) Inventor: Hans-Joachim Stieber, Numberg (DE)

Correspondence Address: KREMBLAS, FOSTER, PHILLIPS & POLLICK, 7632 SLATE RIDGE BOULEVARD, REYNOLDSBURG, OH, 43068, US

(73) Assignee: Koschaum GmbH, Abenberg (DE)

(21) Appl. No.: 11/851,015

(22) Filed: Sep. 6, 2007

(30) Foreign Application Priority Data
Sep. 8, 2006 (DE) 20 2006 014 022.0

(51) Int. Cl. B32B 5/18

(52) U.S. Cl. 428/304.4

(57) ABSTRACT

A layered composite material comprised of a foam material layer which is provided at least partially with a porous plastic coating comprised of a dried (or cured) plastic dispersion.

The invention relates to a layered composite material for cosmetic powder puffs, powder puff elements, powder application brushes, or other devices for application of cosmetics. The “basis body” (basis layer) of such a device is comprised of foam material. The invention further relates to a cosmetics application device realized with the layered composite material, which device may be in particular a cosmetic powder application element which has a plate-like or otherwise flattish basis body comprised of a foam layer.

Cosmetic powder applicators (powder puffs or the like) are known (see e.g. DE 69600100 T2) which are comprised of foam material, e.g. polyester, polyether, polyethylene, polystyrene, polyurethane, polyvinyl chloride, or the like. It is further known to provide a coating of a nap (fibrous) nature on the surface of a foam basis body (see e.g. EP 1046356 A2). However, cosmetic powder applicators with such nap surfaces (or otherwise generally fibrous surfaces) are insufficient to properly handle, e.g., liquid cosmetics, which cause the fibers to adhere to each other, causing smearing of the cosmetic layer which is being applied [to the user's skin].

Known latex sponges fabricated from rubber are better suited for application of moist or liquid cosmetics, because they have a stable consistency. However the round applicator edges which are needed to properly apply cosmetics are difficult to produce on latex sponges; time-consuming and costly cutting methods are required. If one attempts to attain rounded edges by welding as with the above-described foam applicators, instead of generating a proper weld seam the edges merely burn or carbonize, because rubber latex materials are not thermoplastic.

The underlying problem of the present invention was to devise a material for production of powder puffs, powder brushes, powder applicators, or other cosmetic applicator devices, which is easy and economical to produce and which maintains a good and stable consistency when employed with liquid or moist cosmetic products. This problem is solved by a layered composite material as set forth in claim 1, and by a cosmetic applicator device as set forth in claim 7. Optional advantageous refinements of the inventive concept are set forth in the dependent claims.

A layered composite material having a foam layer as a basis body, and products derived from such a material, is/are in fact easy and inexpensive to produce. The novel surface treatment of the foam basis body by dispersions which are suitable for coating and are selected such as to yield a porous nonsmooth surface does in fact provide a good tactile sensation to the user, and good coherence (which coherence is also a characteristic of latex application materials not having the inventive structure). The inventive composite material allows production of products with a pore structure on the surface, a good tactile sensation to the user, and good stability with respect to liquid or moist cosmetics (which are characteristics of latex sponge applicators), and further affords the capability of being easily formed with round edges in the fabrication process, via welding.

Advantageous candidates for use as the plastic dispersion are dispersions of polyurethane (PUR) or other polymer(s) which dispersions are suitable for application and drying (or curing). PUR dispersions are available on the market which are capable of yielding a paint-like smooth surface or a porous surface [(with recesses and the like)]. The types which yield a porous surface may be used according to the invention. In practice, water-based PUR dispersions have proved to be particularly advantageous.

The inventive plastic dispersions afford the capability of adding colorants to the liquid coating dispersion, to achieve desired color effects. This provides additional flexibility to meet optical appearance requirements which a given application may present.

Additional details, features, combinations of features, effects, and advantages associated with the invention will be apparent from the following description of a preferred embodiment of the invention, and from the drawings.

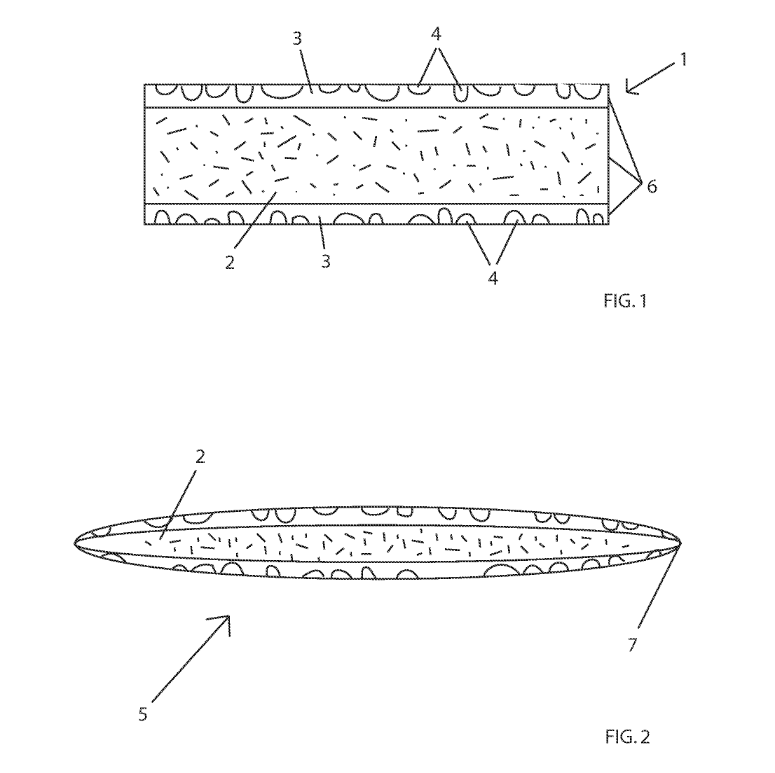

FIG. 1 is an illustration of the structure of an embodiment of an inventive layered composite material; and

FIG. 2 is an illustration of a cosmetic powder applicator element fabricated from the described material.

According to FIG. 1, the layered composite material 1 is formed with a foam material 2 as the basis material (“basis body”). In its initial state, it [sic] has a flattish rectangular or square shape. The foam layer 2 bears on each of its opposite wide sides a porous polyurethane (PUR) dispersion layer 3. The thickness of each such layer 3 is substantially less than the thickness of the basis layer 2. The PUR dispersion layer 3 forms a porous surface with a plurality of non-uniformly distributed small recesses (pores) (or blisters) 4, which serve to accommodate the cosmetic being applied.

Suitable water-based dispersions comprising finely dispersed PUR, which have suitable properties, are per se known and are available on the market. Such an aqueous PUR dispersion is applied to the foam layer 2 to form the inventive layered composite material. In the next step, the applied dispersion is dried (or cured), resulting in the PUR dispersion coating layer 3 with pores (or recesses etc.) 4.

According to FIG. 2, the layered composite material 1 has undergone further processing to form a cosmetic powder applicator element 5. The two originally oppositely disposed PUR dispersion coating layers 3 have been joined together by welding at their edges 6, to form a weld seam 7. At the same time, the original edges of the foam layer which edges had abrupt corners have now become rounded.

### LIST OF REFERENCE NUMERALS

1 layered composite material.
2 foam layer.
3 polyurethane (PUR) dispersion coating.
4 pore or recess or the like.
5 powder applicator (e.g. powder puff) or powder applicator element or powder brush element.
6 edge.
7 weld seam.

1. A layered composite material (1) comprised of a foam material layer (2) which is provided at least partially with a porous plastic coating (4) comprised of a dried or cured plastic dispersion (3).

2. A layered composite material (1) according to claim 1; characterized in that the plastic dispersion (3) is a dispersion of polyurethane or another plastic which dispersion is suitable for coating and drying or curing.

3. A layered composite material (1) according to claim 2; characterized in that the dispersion (3) is water-based.

4. A layered composite material (1) according to claim 3; characterized in that the dispersion (3) comprises a fine dispersion of polyurethane or other polymer particles in water.

5. A layered composite material (1) according to claim 3; characterized in that the foam layer (2) comprises polyester, polyether, polyethylene, polystyrene, polyurethane, or polyvinyl chloride material.

6. A cosmetic powder brush element (5) for application of cosmetics, comprised of a layered composite material (1) according to claim 1; characterized in that the foam layer (2) is in the form of a plate-like and or otherwise generally flat base body, to at least one side of which the plastic dispersion (3) has been applied in liquid form and has been dried (or cured) to form a porous surface (4).

7. A cosmetic powder brush element according to claim 6; characterized in that the base body has been coated on two opposite (or parallel) lateral and/or end sides with the plastic dispersion (3), and the two coatings have been joined via a weld seam (7) at the periphery of the plate or the like or at the edge of the base body (6).

8. A layered composite material (1) according to claim 4, characterized in that the foam layer (2) comprises polyester, polyether, polyethylene, polystyrene, polyurethane, or polyvinyl chloride material.

9. A layered composite material (1) according to claim 1; characterized in that the plastic dispersion (3) is a dispersion of polyurethane which dispersion is suitable for coating and drying or curing.
